(19) United States
(12) Patent Application Publication
(10) Pub. No.: US 2019/0034847 A1
(43) Pub. Date: Jan. 31, 2019

(54) METHOD AND SYSTEM FOR PLANNING ROUTES FOR COMMERCIAL MOTOR VEHICLES

(71) Applicant: J. J. Keller & Associates, Inc., Neenah, WI (US)

(72) Inventor: Benjamin Mark Vollbrecht, Oshkosh, WI (US)

(21) Appl. No.: 15/660,178

(22) Filed: Jul. 26, 2017

(51) Int. Cl. G06Q 10/06; H04W 4/02

(52) U.S. Cl. CPC G06Q 10/06311; H04W 4/021

(57) ABSTRACT

Device, system and method for planning routes based on historical activity within a geo-fenced region. In one example, the system, method, and apparatus include receiving geo-fence activity data associated with a plurality of users of vehicles entering into a geo-fenced region and exiting out of the geo-fenced region; generating hours-of-service data associated with the plurality of users of vehicles; determining a geo-fence activity time associated with the plurality of users of vehicles based on the geo-fence data; determining an hours-of-service availability time for each of the plurality of users of vehicles based on the hours-of-service data and the geo-fence activity associated with each of the plurality of users of vehicles; determining a compliant route for a first vehicle based on the hours-of-service availability time; and displaying the compliant route for the first vehicle.

### TECHNICAL FIELD

Embodiments relate to methods and systems for planning routes for commercial motor vehicles.

### BACKGROUND

Commercial motor vehicles (CMV) and their respective drivers and carriers are required by various federal regulations and international agreements to comply with rules governing the safe operation of the vehicles. One way in which safety is promoted is through hours-of-service (HOS) regulations. These regulations prohibit drivers from operating vehicles more than a specified amount of time between mandatory off-duty status periods. In many instances, dispatchers are responsible for routing drivers. For example, a dispatcher sends a driver a preplanned travel route, which may have one or more preplanned stops based on the projected travel time and the maximum number of driving hours for the particular driver. However, various road conditions (such as traffic, construction, etc.) and driver associated situations (for example, taking time for off-duty status at a restaurant, diner, or like) can dynamically change and result in the driver not being able to meet hours-of service regulations.

### SUMMARY

As a consequence of changing road and driver conditions, it is desirable to have a system for route planning that can accommodate such dynamics. Calculating hours-of-service availability using current methods can be a time-consuming process because it involves tracking the time spent by a large number of drivers inside a geo-fence. Additionally, keeping track of the amount of time spent in each hours-of-service status for these drivers inside a geo-fence adds to the level of complexity. Methods and systems provided herein allows to combine all of the above data to determine and display (using a graphical user interface) particular routes for drivers to take while staying compliant to the hours-of-service requirements. Embodiments provided herein help improve compliance with hours-of-service regulations and provides an efficient routing system for commercial motor vehicles. Additionally, embodiments of the invention also improves order processing efficiency resulting in improved fuel efficiency, wear and tear on commercial motor vehicles. More efficient routing, for example, routing that avoids road construction, accidents, etc., reduces fuel consumption. Moreover, embodiments provided herein include a graphical user interface to display compliant routes with respect to hours-of-service requirements on which commercial motor vehicles may be deployed. Furthermore, data transmissions are reduced as a result of less instances of hours of service violations. Of course, fuel consumption is a significant issue for operators of commercial vehicles and has significant impacts on both operating costs and the generation of greenhouse gases and other potentially undesirable emissions.

Various systems and methods are described in connection with route planning for commercial vehicles. One embodiment provides a base unit comprising an electronic processor configured to receive geo-fence activity data associated with a plurality of users of vehicles entering into a geo-fenced region and exiting out of the geo-fenced region; generate hours-of-service data associated with the plurality of users of vehicles; determine a geo-fence activity time associated with the plurality of users of vehicles based on the geo-fence activity data; determine an hours-of-service availability time for each of the plurality of users of vehicles based on the hours-of-service data and the geo-fence activity associated with each of the plurality of users of vehicles; determine a compliant route for a first vehicle based on the hours-of-service availability time; and display the compliant route for the first vehicle.

Another embodiment provides a system for planning routes based on historical activity within a geo-fenced region. The system includes a base unit including an electronic processor configured to receive geo-fence activity data associated with a plurality of users of vehicles entering into a geo-fenced region and exiting out of the geo-fenced region; generate hours-of-service data associated with the plurality of users of vehicles; determine a geo-fence activity time associated with the plurality of users of vehicles based on the geo-fence activity data; determine an hours-of-service availability time for each of the plurality of users of vehicles based on the hours-of-service data and the geo-fence activity associated with each of the plurality of users of vehicles; determine a compliant route for a first vehicle based on the hours-of-service availability time; and display the compliant route for the first vehicle.

Another embodiment provides a method for planning routes based on historical activity within a geo-fenced region. The method includes receiving geo-fence activity data associated with a plurality of users of vehicles entering into a geo-fenced region and exiting out of the geo-fenced region; generating hours-of-service data associated with the plurality of users of vehicles; determining a geo-fence activity time associated with the plurality of users of vehicles based on the geo-fence data; determining an hours-of-service availability time for each of the plurality of users of vehicles based on the hours-of-service data and the geo-fence activity associated with each of the plurality of users of vehicles; determining a compliant route for a first vehicle based on the hours-of-service availability time; and displaying the compliant route for the first vehicle.

Thus, embodiments described herein, provide, among other things, methods and systems for planning routes for commercial motor vehicles. Other aspects of the various embodiments will become apparent by consideration of the detailed description and accompanying drawings that follow.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 schematically illustrates a route planning system in accordance with some embodiments.

FIG. 2 is a block diagram of a base unit included in the system of FIG. 1 in accordance with some embodiments.

FIG. 3 is a block diagram of the memory of the base unit shown in FIG. 2, in accordance with some embodiments.

FIG. 4 illustrates a commercial motor vehicle operating within a geo-fenced region, in accordance with some embodiments.

FIG. 5 is diagram illustrating the method of route planning based on historical activity, in accordance with some embodiments.

FIG. 6 is a flow chart illustrating a method for planning routes based on historical activity within a geo-fenced region, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Electronic logging devices (ELD) (for example, a base unit) may contain hardware, software, and other components that are used to determine the position of commercial motor vehicle (CMV). ELDs are subject to particular accuracy and availability requirements mandated by the Federal Motor Carrier Safety Administration (FMCSA). Embodiments provided herein allow for planning routes or choosing jobs for commercial motor vehicles by predicting how a geographic region will affect a particular driver's Hours-of-Service availability time that is remaining. A route planning application analyzes prior activity of commercial motor vehicles inside a geo-fenced region and determines Hours-of-Service violations for drivers and assists in scheduling routes for commercial motor vehicles. Additionally, the route planning application provided herein analyzes Hours-of-Service requirements based on the geographical location of commercial motor vehicles and the time accumulated by drivers of commercial vehicles in various categories including “On-duty status,” “Driving status,” “On-duty Not Driving status,” “off-duty status,” “sleeper berth status,” etc. Being able to analyze specific regions and conditions that have the biggest impact on Hours-of-Service time could help customers avoid jobs that have a history of delays compared to other regions. Currently available systems are inefficient in routing commercial motor vehicles because they often do not take into account Hours-of-Service related data associated with the drivers along with geo-fence activity data. Using embodiments provided herein, drivers can be sent to more jobs without violating Hours-of Service limits stipulated by the Federal Motor Carrier Safety Administration.

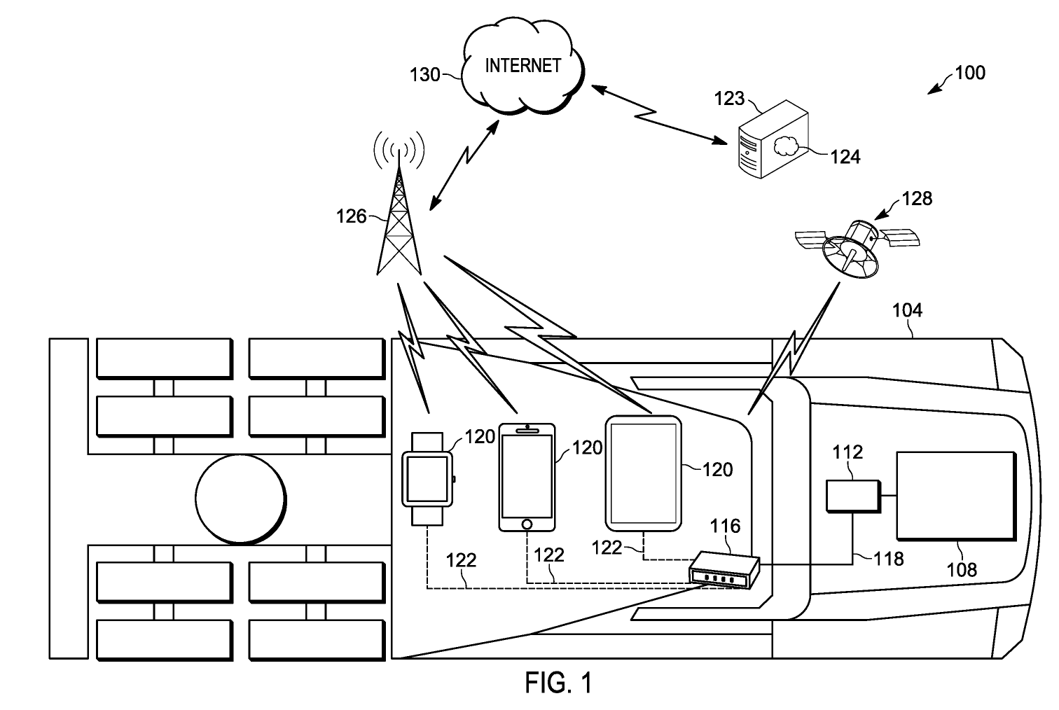

FIG. 1 illustrates a route planning system 100 for use with a vehicle 104. Although the vehicle 104 is illustrated as a commercial vehicle in the form of a tractor configured to tow a trailer (not shown), the route planning system 100 can also be implemented in or otherwise used in connection with other types of vehicles, such as construction vehicles, agricultural equipment, and passenger vehicles. The vehicle 104 includes an engine 108 (for example, an internal combustion engine) that supplies mechanical power to the vehicle 104. The engine 108 is controlled by an electronic control unit (ECU) 112. The ECU 112 monitors operating parameters of the vehicle 104 and controls the engine 108 and other parts of the vehicle 104 based on the monitored parameters. Operating parameters monitored by the ECU 112 include speed, hours of engine operation, ignition state, trip distance, total distance traveled by vehicle 104, and the like.

In one embodiment, the route planning system 100 includes an electronic on-board recorder (“EOBR”) base unit 116, one or more portable communication devices 120 (that are external to the base unit 116), and a remote server 123 running a host application 124. In the example illustrated in FIG. 1, the base unit 116 communicates with the ECU 112 through a data bus 118. The base unit 116 also communicates with the portable communication devices 120 through a wired or wireless link 122. The portable communication device 120 may be a smart phone, a tablet computer, a laptop computer, a smart watch, or another computing device upon which software can be readily run, that can wirelessly connect to other devices, and that can be carried and moved by a user. In the example illustrated in FIG. 1, the portable communication device 120 wirelessly communicates with the remote server 123 over a communication network 130 using a cellular network connection with a cellular tower 126 or the Internet (for example, using a Wi-Fi connection).

The base unit 116 performs a plurality of functions including, for example, time keeping and data logging. In one implementation, the base unit 116 records and stores vehicle data (for example, data for complying with Federal Motor Carrier Safety Administration (“FMCSA”) regulations), such as vehicle operating parameters monitored by the ECU 112.

In the example shown, the base unit 116 is powered via a connection to a battery (for example, a 12 volt or 24 volt vehicle battery). In some embodiments, the base unit 116 is configured to operate in a fully operational mode and a sleep mode to conserve power. When the base unit 116 is in the fully operational mode, the base unit 116 obtains and, in some instances stores vehicle data received from the ECU 112. For example, data may be obtained by the base unit 116 from the ECU 112 substantially in real-time or at a predefined frequency or interval. When the base unit 116 is communicatively coupled with the portable communication device 120, the base unit 116 may obtain data (for example, data related to positioning information) from the portable communication device 120 substantially in real-time or at a predefined frequency or interval. In one example, the base unit 116 can send data regarding the vehicle 104 and a request for positioning information to the portable communication device 120.

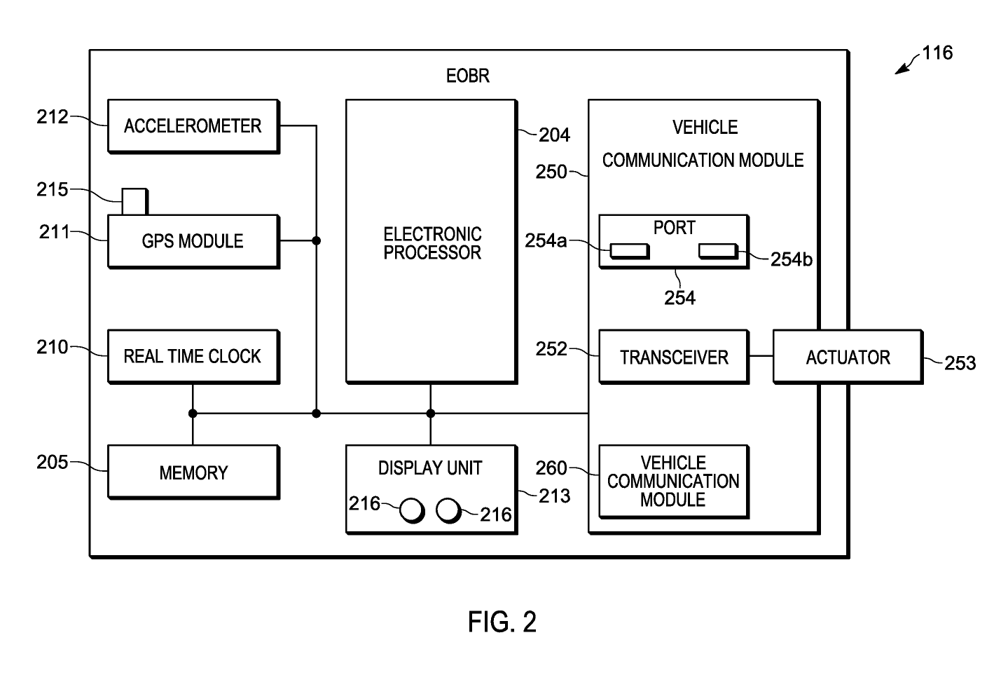

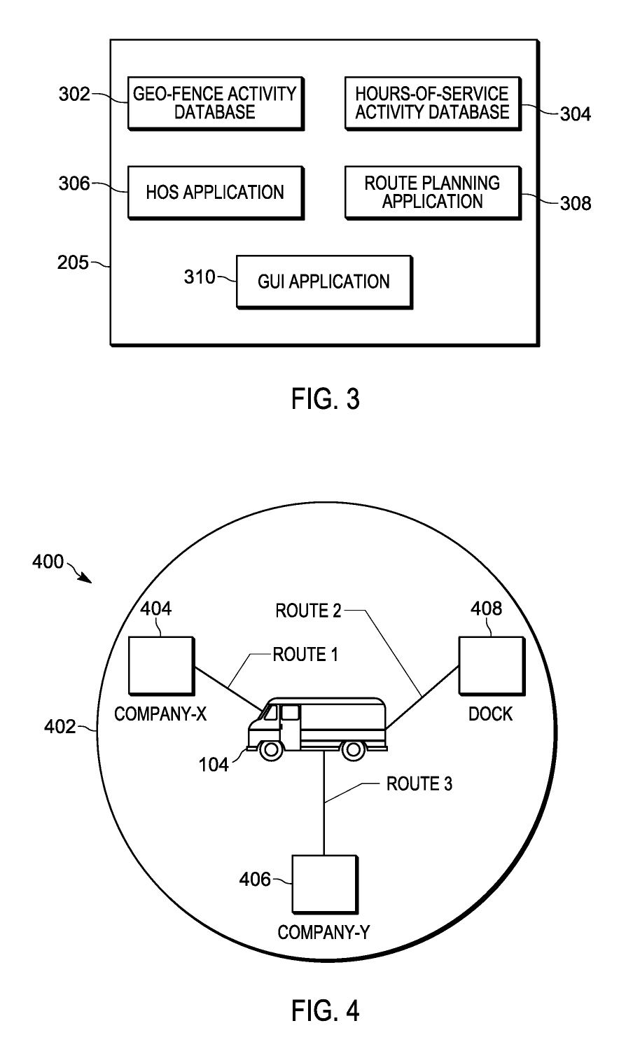

In the example shown in FIG. 2, the base unit 116 includes an electronic processor 204 (such as a microprocessor, controller, or application-specific-integrated circuit (“ASIC”) and at least one memory 205. The memory 205 includes non-transitory computer readable medium. In some embodiments, the memory 205 includes a geo-fence activity database 302 and an hours-of-service activity database 304 (shown in FIG. 3). As described in more detail below, the memory 205 stores instructions that, when executed by the electronic processor 204, logs vehicle data, logs data retrieval history, logs geo-fence activity data, logs hours-of-service activity data, and processes data received from the ECU 112 and other devices and systems external to the base unit 116. Accordingly, as described herein, the base unit 116 performs particular functionality by executing instructions with the electronic processor 204.

In the example shown, the base unit 116 also includes a clock 210, a position information device 211, such as global positioning system (“GPS”) receiver, an accelerometer 212, and a display unit 213. The clock 210 provides a clock function to allow the base unit 116 to accurately determine a time with a predetermined resolution (for example, approximately one second). The clock 210 is powered by a battery that provides power to the clock 210 even when the vehicle 104 does not provide power to the base unit 116. In some embodiments, the clock 210 is configured to obtain an updated time from the GPS 211.

The GPS receiver 211 includes an antenna 215, which can be internal to the base unit 116. Positioning the antenna 215 internal to the base unit 116 makes the antenna 215 more tamper-proof than if the antenna 215 were positioned external to the base unit 116. Based on data received by the antenna 215 from one or more external satellites 128 (see FIG. 1), the GPS receiver 211 provides positioning information to the electronic processor 204. The positioning information can include coordinates (for example, latitude and longitude coordinates), a speed, a heading, a time, and a quality value. In some embodiments, the GPS receiver 211 updates the positioning information at a predetermined frequency (for example, approximately once per second). The GPS receiver 211 remains active when the vehicle 104 is in motion and whenever the vehicle ignition is “on.” When the base unit 116 is in sleep mode, the GPS receiver 211 may be activated periodically after a predetermined period of time. In some embodiments, the base unit 116 may not include the GPS receiver 211, or the accelerometer 212 as described above.

The display unit 213 displays data to a user of the base unit 116. For example, the display unit 213 can include one or more LEDs 216. The LEDs 216 indicate a status of the base unit 116. For example, the LEDs 216 can be used to indicate whether the portable communication device 120 connected to the base unit 116 is properly functioning (for example, a connection status), whether signals are being communicated between the base unit 116 and the ECU 112 (for example, a communication status), and whether signals are being communicated between the base unit 116 and the portable communication device 120 (for example, a mobile communication device communication status). The LEDs 216 can include different colored LEDs and can be configured to flash at different frequencies to signal different statuses of the base unit 116. As an alternative to or in addition to the LEDs 216, the display unit 213 can be configured to provide data to a user through other output mechanisms, such as displaying a textual and/or graphical message, playing an audio sound or message, providing tactile feedback (for example, vibration), or a combination thereof.

The base unit 116 also includes a vehicle communication module 250. As illustrated in FIG. 2, the vehicle communication module 250 includes a transceiver 252 for communicating data between the base unit 116 and the portable communication device 120. The transceiver 252 can communicate with the portable communication device 120 using a wired or wireless connection. For example, as described above, in some embodiments, the base unit 116 communicates with the portable communication device 120 using a Bluetooth connection. Accordingly, the transceiver 252 can include a Bluetooth transceiver. In some embodiments, the transceiver 252 can be configured to automatically search and discover other Bluetooth-enabled devices. In some embodiments, the base unit 116 includes a connection actuator 253 that allows a user to control when the base unit 116 becomes discoverable or searchable. For example, in some embodiments, pressing the connection actuator 253 for a predetermined period of time (for example, three seconds) makes the base unit 116 discoverable by a Bluetooth-enabled portable communication device 120. Also, if the base unit 116 is operating a sleep mode, pressing the connection actuator 253 wakes up the electronic processor 204 and enables communication between the base unit 116 and the portable communication device 120. In some embodiments, the base unit 116 is also configured to automatically become discoverable or searchable for a predefined period of time after the base unit 116 is powered or reset and for a predefined period of time after the base unit 116 enters a sleep mode.

When the base unit 116 is discoverable, the portable communication device 120 can search for, discover, and communicably couple to the base unit 116. In some embodiments, the base unit 116 couples to the portable communication device 120 and functions as a slave unit. Once the portable communication device 120 is communicably coupled to the base unit 116, the display unit 213 of the base unit 116 can indicate a status of the connection or coupling. For example, when the base unit 116 is discoverable or searchable, one or more of the LEDs 216 can flash, and, when the base unit 116 is communicably coupled to the portable communication device 120, the one or more LEDs 216 can provide a solid light. After the portable communication device 120 and the base unit 116 are communicably coupled, the portable communication device 120 and the base unit 116 can exchange data. For example, as described above, the base unit 116 can transmit vehicle data to the portable communication device 120. It should be understood that even when the transceiver 252 is transmitting vehicle data to the portable communication device 120, the base unit 116 continues to monitor and record new vehicle data from the ECU 112 and other devices and systems (for example, the GPS receiver 211, the accelerometer 212, etc.).

As illustrated in FIG. 2, the vehicle communication module 250 also includes a port 254 for physically coupling the portable communication device 120 to the base unit 116. The port 254 allows diagnostic data to be transmitted between the portable communication device 120 and the base unit 116. In some embodiments, the port 254 includes one or more universal serial bus (USB) connections. For example, the port 254 can include a first connection 254a and a second connection 254b. The first connection 254a is used to transmit diagnostic data regarding the base unit 116 to the portable communication device 120 but does not provide a charging current to the portable communication device 120. The second connection 254b is used to provide a charging current to the portable communication device 120. By providing two separate connections, one for charging and one for data transmission, the base unit 116 does not need to include an isolated DC power supply.

The diagnostic data transmitted through the port 254 can relate to the base unit 116 (as compared to the ECU 112 or other components of the vehicle 104). Therefore, a user can couple the portable communication device 120 to the port 254 to diagnose a malfunction occurring with the base unit 116. Similarly, the port 254 can allow the base unit 116 to be reconfigured, modified, or upgraded using the portable communication device 120. The vehicle communication module 250 also includes a vehicle communication module 250 for communicating with the ECU 112.

FIG. 3 is a block diagram showing the memory 205 of base unit 116, in accordance with some embodiments. In some embodiments, the memory 205 includes a geo-fence activity database 302, an hours-of-service activity database 304, a HOS application 306, a rout planning application 308 and a GUI application 310.

In some embodiments, the geo-fence activity database 302 stores data associated with several aspects of commercial vehicles performing jobs on several routes within a geo-fence (for example, 402 in FIG. 4). For example, some of these aspects may include the time of entry into the geo-fence 402, the time of exit from the geo-fence 402, the various locations and associated time that the commercial motor vehicles stop at and travel through, etc.

In some embodiments, the hours-of-service activity database 304 stores various hours-of-service data associated with users of a commercial motor vehicles performing jobs on several routes within the geo-fence 402. Some examples of the hours-of-service data include various times associated with “On-duty status,” “Driving status,” “On-duty Not Driving status,” “off-duty status,” “sleeper berth status,” etc.

In some embodiments, the HOS application 306 includes a computer program that determines the compliance of users of commercial motor vehicles based on the hours-of-service data stored in the hours-of-service activity database and the various statutory requirements stipulated by FMCSA.

In some embodiments, the HOS application 306 takes additional considerations into account to calculate the hours-of-service availability time as there are many variations of HOS regulations that a driver must comply with based on their location, each with their own limits and rules. For example, federal regulations currently restrict a bus driver transporting passengers to only driving 10 hours per day, but a truck driver transporting property may drive 11 hours per day. Regulations also limit the amount of on duty time a driver may have over a number of days. Federal regulations limit on duty time to no more than 70 hours in an 8 day period. However, some regulations allow this limit to be reset by spending time off duty, and the amount of off duty time required differs between different regulations. Federal regulations require 34 hours of off duty time to reset the limit, but a driver using federal regulations for oil fields can reset the limit in 24 hours of off duty time. There are also different ways to count how off duty time throughout a day affects the daily on duty limits, which makes calculations more complicated. For example, a property-carrying driver's on duty time is counted consecutively from the time they started regardless of any off duty time during the day. However, a passenger-carrying driver's on duty time is only counted when they are on duty; off duty time is not counted toward the daily limit. There are also exceptions to specific regulations that a driver can take advantage of if they meet eligible requirements, such as a federal exemption that can extend a driver's on duty limit to 16 hours or an oil field wellsite exemption that allows drivers to spend time off duty that doesn't count toward their daily on duty time.

In some embodiments, the route planning application 308 includes a computer program that determines a compliant route based on the hours-of-service availability time associated with a particular user (for example, a driver) of the commercial motor vehicle 104.

In some embodiments, the GUI application 310 allows for the display of a compliant route on a map on the display unit 213 showing various locations associated with possible jobs for a user of the commercial motor vehicle 104.

FIG. 4 illustrates the commercial motor vehicle 104 operating within a geo-fenced region 402, in accordance with some embodiments. As shown in FIG. 4, the geo-fenced region 402 includes three customer locations namely company-X 404, company-Y 406, and a dock 408 that is used during loading and unloading of the commercial motor vehicle 104. Typically, a scheduler (either manually or using a computer application) would schedule drivers to service (or travel to) the three locations based on their availability. FIG. 4 also shows several routes that the commercial motor vehicle 104 can take. These include Route 1 to company-X 404, Route 2 to the dock 408, and Route 3 to Company-Y 406.

According to FMCSA, “On-duty time” is defined as time from when a driver begins or is required to be in readiness for work until the time the driver is relieved from work and all responsibilities for performing work. Performing other compensated work for a person who is not a motor carrier is also on-duty time. “Driving time” is defined as all time spent at the driving controls of a commercial motor vehicle in operation. If a driver is seated at the driving controls of the vehicle, is able to simultaneously perform the driving and auxiliary function (for example, one hand on the steering wheel and one hand on a control mechanism), the time spent performing the auxiliary function muse be recorded as “Driving time.” If a driver, seated at the driving controls of the vehicle, is unable to simultaneously perform the driving and auxiliary function, the time spent performing the auxiliary function may be recorded as “On-duty Not Driving time”. The time spent in the vehicle would be considered as being in “on-duty status” (not driving) if a driver is dispatched to another job once he/she reaches a first terminal, and is in “off-duty status” if he/she is given 8 consecutive hours “off-duty time” upon reaching the terminal. “Off-duty time” is any time that the driver is not in “driving status,” “on-duty status,” or “sleeper berth status.” A driver may use a sleeper berth in the vehicle to rest and this time would be considered as “sleeper berth time.”

The systems and methods described herein provide a mechanism to calculate the historical averages of the time taken to service each of these locations and determine if any of the three locations will likely cause the driver to violate his/her hours-of-service limits.

The type of hours-of-service analysis provided herein assists a customer determine as to which customers are more efficient at releasing their drivers so they can chose the most cost-effective customers. The route planning system 100 is capable of analyzing the locations where the drivers spend the least “On-duty time,” which would be an indicator that their drivers are able to spend most of their time diving instead of waiting.

The system and methods provided herein uses a combination of databases (for example, geo-fence activity database 302, and hours-of-service activity database 304) to calculate the average time that previous drivers have spent within the geo-fenced region 402 for various hours-of-service (HoS) duty classifications, namely: “off-duty status,” “off-duty wellsite status,” “sleeper berth status,” “driving status,” and “on-duty status” With the various historical averages available for several drivers and routes, the route planning system 100 is able to predict the expected effect that characteristics within a geo-fence will have on a route or job that is to be scheduled.

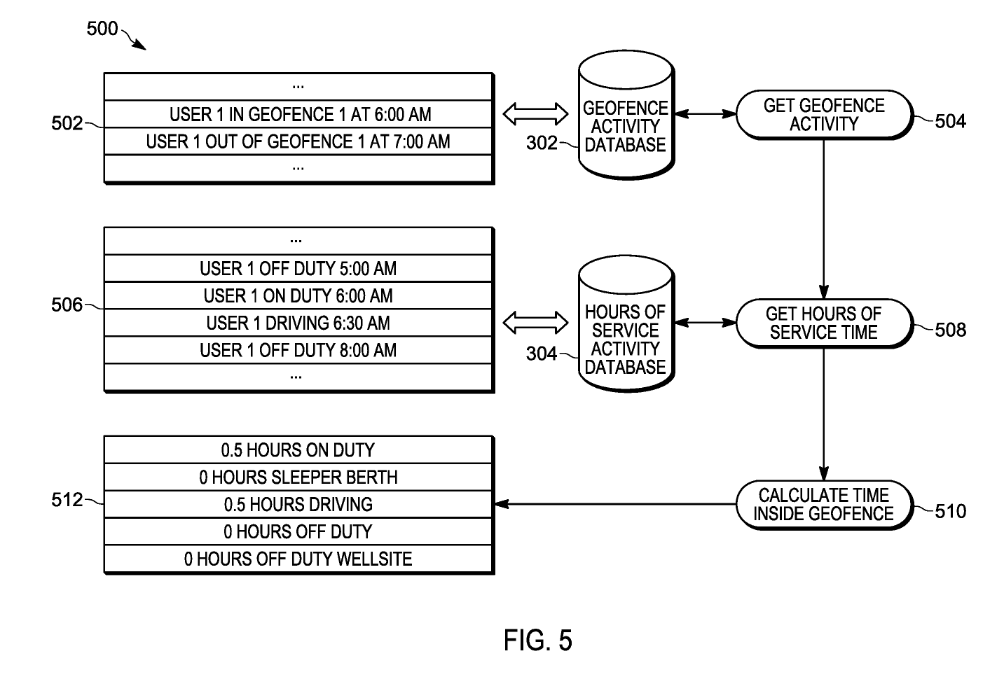

FIG. 5 illustrates the method 500 for planning routes based on historical activity, in accordance with some embodiments. At block 504, the method 500 receives geo-fence activity from the geo-fence activity database 302. The geo-fence activity database 302 stores in a record 502 the activities (for example, entry into and exit out of the geo-fenced region 402) of “User 1” within the geo-fence region 402. As shown in FIG. 5, the record 502 shows that “User 1” enters geo-fence at “6.00 AM” and exits the geo-fence at “7.00 AM.” At block 508, the method 500 receives hours-of-service times from the hours-of-service activity database 304. The hours-of-service activity database 304 stores in a record 504 the hour-of-service times (for example, times associated with “off-duty status,” “on-duty status,” etc.). For example, the record 504 shows that the “User 1” began “off-duty status” at “5.00 AM,” and switched to “on-duty status” at “6.00 AM,” began “driving status” at “6.30 AM,” and resumed “off-duty status” at “8.00 AM.”

At block 510, the method 500 calculates a geo-fence activity time that “User 1” spends with the geo-fenced region 402 according to the various classifications of status stipulated by the FMCSA. For example, based on the data present in the record 502 and the record 504 (shown in FIG. 5), the method 500 calculates that “User 1” has been in “on-duty status” for 0.5 hours; “sleeper berth status” for 0 hours; “driving status” for 0.5 hours; “off-duty status” for 0 hours; and “off-duty wellsite status” for 0 hours.

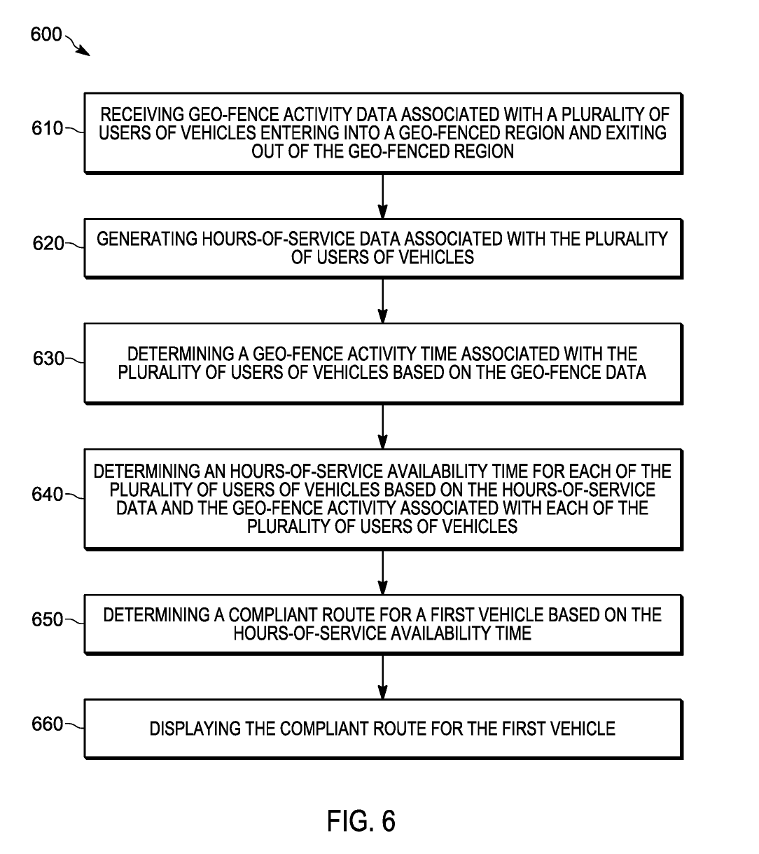

FIG. 6 is a flow chart illustrating a method 600 for planning routes based on historical activity within the geo-fenced region 402, in accordance with some embodiments.

At block 610, the method 600 includes receiving, with an electronic processor 204, geo-fence data associated with a user of the vehicle 104 entering a geo-fenced region 402 and exiting out of the geo-fenced region 402. For example, “User 1” enters the geo-fenced region 402 at 6 AM and exits the geo-fenced region 402 at 7 AM (as shown in FIG. 5).

At block 620, the method 600 includes receiving, with the electronic processor 204, the hours-of-service data associated with the user of the vehicle 104. For example, the hours-of-service data includes “User 1” entering “off-duty status” at 5 AM, entering “on-duty status” at 6 AM, entering “driving” status at 6.30 AM, and entering “off-duty status” at 8 AM (as shown in FIG, 5).

At block 630, the method 600 includes determining, with the electronic processor 204, the geo-fence activity time (for example, the time spent in one or more of the following statuses, such as “off-duty status,” “off-duty Wellsite status,” “sleeper berth status,” “driving status,” and “on-duty status”) associated with the user of the vehicle 104 based on the geo-fence data. For example, “User 1” spends) 0.5 hours in “on-duty status,” 0 hours in “sleeper berth status,” 0.5 hours in “driving status,” 0 hours in “off-duty status,” and 0 hours in “off-duty Wellsite status” (as shown in FIG. 5).

At block 640, the method 600 includes determining, with the electronic processor 204, an available time for the user of the vehicle 104 based on the hours-of-service data and the geo-fence activity time. In some embodiments the hours-of-service data and the geo-fence activity time is associated with at least one selected from the group consisting of off-duty status, off-duty wellsite status, sleeper berth status, driving status, and on-duty status. In some embodiments, the method 600 includes determining, with the electronic processor 204, an average time associated with the duty status for a plurality of previous users inside the geo-fenced region 402.

For example, assume that a driver has 2 hours of “driving time” left and 4 hours of “on-duty time” remaining based on their hours-of-service limits. Additionally, the geo-fence activity database 302 has captured the following activities for various drivers within the geo-fenced region 402.

Route 1 to Company-X 404: Drivers to this location typically spend 1 hour of “drive time” and 2 hours of “on-duty time.”

Route 2 to Dock 408: Drivers to this location typically spend 3 hours of “drive time” because of traffic at dock 408.

Route 3 to Company-Y 406: Drivers to this location typically spend 1 hour of “drive time” and only 2 hours of “on-duty” time because they spend 2 hours of “off-duty” time at a nearby restaurant.

Previously, the scheduler would have only known that the driver scheduled for a job at dock 408 would typically spends 3 hours at a location based on the timing corresponding to GPS coordinates associated with the CMV at various locations within the geo-fenced region 402. On the other hand, systems and methods provided herein determines that the driver would spend most of their time in “drive time,” which would cause a violation of the FMCSA regulations.

At block 650, the method 600 includes generating, with the electronic processor 204, a route for the vehicle 104 based on the available time. In the example shown above, the route planning system 100 will be able to select the company-X 404 (which required only 1 hour “drive time”) as the next job location for this particular driver who still has 2 hours of “Drive time” remaining. The method 600 includes determining, with the electronic processor 204, that the user of the vehicle 104 does not violate an hours-of-service requirement when choosing a particular job.

Additionally, if the driver is using a non-consecutive hours-of-service rule set, the route planning system 100 would be able to recommend company-Y 406 as an option as compared to before when this option might not have been considered because it seems like drivers spend 5 total hours there without the information that 2 hours there was spent as “Off duty time.”

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A base unit comprising:
an electronic processor configured to
receive geo-fence activity data associated with a plurality of users of vehicles entering into a geo-fenced region and exiting out of the geo-fenced region;
generate hours-of-service data associated with the plurality of users of vehicles;
determine a geo-fence activity time associated with the plurality of users of vehicles based on the geo-fence activity data;
determine an hours-of-service availability time for each of the plurality of users of vehicles based on the hours-of-service data and the geo-fence activity associated with each of the plurality of users of vehicles;
determine a compliant route for a first vehicle based on the hours-of-service availability time; and
display the compliant route for the first vehicle.

2. The base unit of claim 1, wherein the hours-of-service data and the geo-fence activity time is associated with an item selected from the group consisting of off-duty status, off-duty wellsite status, sleeper berth status, driving status, and on-duty status.

3. The base unit of claim 1, wherein the geo-fence activity data includes data associated with an activity of the plurality of users of vehicles within the geo-fenced region.

4. The base unit of claim 1, wherein the electronic processor is further configured to
determine an average time associated with a duty status for a plurality of previous users inside the geo-fenced region.

5. The base unit of claim 1, wherein the electronic processor is further configured to
determine a first user of the first vehicle does not violate an hours-of-service requirement when choosing a job.

6. The base unit of claim 1 wherein the electronic processor is further configured to receive the geo-fence activity data associated with the plurality of users of vehicles from a geo-fence activity database.

7. The base unit of claim 1 wherein the electronic processor is further configured to receive the hours-of-service data associated with a first user of the first vehicle from an hours-of-service activity database.

8. A system for planning routes based on historical activity within a geo-fenced region, the system comprising:
a base unit including an electronic processor configured to
receive geo-fence activity data associated with a plurality of users of vehicles entering into a geo-fenced region and exiting out of the geo-fenced region;
generate hours-of-service data associated with the plurality of users of vehicles;
determine a geo-fence activity time associated with the plurality of users of vehicles based on the geo-fence activity data;
determine an hours-of-service availability time for each of the plurality of users of vehicles based on the hours-of-service data and the geo-fence activity associated with each of the plurality of users of vehicles;
determine a compliant route for a first vehicle based on the hours-of-service availability time; and
display the compliant route for the first vehicle.

9. The system of claim 8, wherein the hours-of-service data and the geo-fence activity time is associated with a duty status selected from the group consisting of off-duty status, off-duty wellsite status, sleeper berth status, driving status, and on-duty status.

10. The system of claim 8, further comprising:
a remote server including a geo-fence activity database to store the geo-fence activity data.

11. The system of claim 10, wherein the remote server includes a hours-of-service activity database to store the hours-of-service data.

12. The system of claim 8, the geo-fence activity data includes data associated with the activity of the plurality of users of vehicles within the geo-fenced region.

13. The system of claim 9, wherein the electronic processor is further configured to
determine an average time associated with the duty status for a plurality of previous users inside the geo-fenced region.

14. The system of claim 8, wherein the electronic processor is further configured to
determine a first user of the first vehicle does not violate an hours-of-service requirement when choosing a job.

15. A method for planning routes based on historical activity within a geo-fenced region, the method comprising:
receiving geo-fence activity data associated with a plurality of users of vehicles entering into a geo-fenced region and exiting out of the geo-fenced region;
generating hours-of-service data associated with the plurality of users of vehicles;
determining a geo-fence activity time associated with the plurality of users of vehicles based on the geo-fence data;
determining an hours-of-service availability time for each of the plurality of users of vehicles based on the hours-of-service data and the geo-fence activity associated with each of the plurality of users of vehicles;
determining a compliant route for a first vehicle based on the hours-of-service availability time; and
displaying the compliant route for the first vehicle.

16. The method of claim 15, wherein the hours-of-service data and the geo-fence activity time is associated with a duty status selected from the group consisting of off-duty status, off-duty wellsite status, sleeper berth status, driving status, and on-duty status.

17. The method of claim 15, further comprising:
determining a first user of the first vehicle does not violate an hours-of-service requirement when choosing a job.

18. The method of claim 16, further comprising:
determining an average time associated with the duty status for a plurality of previous users inside the geo-fenced region.
